(19) United States
(12) Patent Application Publication
(10) Pub. No.: US 2007/0245226 A1
(43) Pub. Date: Oct. 18, 2007

(54) DATA PROCESSING APPARATUS AND METHOD

(76) Inventor: Tadaomi Tsutsumi, Yokohama-shi (JP)

Correspondence Address: MORGAN & FINNEGAN, L.L.P., 3 WORLD FINANCIAL CENTER, NEW YORK, NY, 10281-2101, US

(21) Appl. No.: 11/691,053

(22) Filed: Mar. 26, 2007

(30) Foreign Application Priority Data
Apr. 13, 2006 (JP) 2006-111362

(51) Int. Cl. G06F 17/00; G06F 17/30

(52) U.S. Cl. 715/505; 707/10; 715/506; 715/507

(57) ABSTRACT

A data processing apparatus discriminates a designated template and outputs a data registration sheet using the designated template. The data processing apparatus reads data that has been recorded on a sheet and registers the read data in accordance with the designated template. Further, the data processing apparatus outputs a data output sheet using the data and the designated template.

### BACKGROUND OF THE INVENTION

1. Field of the Invention

The present invention relates to a data processing apparatus and method.

2. Description of the Related Art

Services utilizing a database on a network are available, an example being CRM (Customer Relationship Management) provided by an ASP (Application Service Provider). In a case where data is registered on a database in such a service, use is made of a special-purpose application or web browser that has been installed in a personal computer, PDA (Personal Digital Assistant) or mobile telephone, etc. (e.g., see Japanese Patent Application Laid-Open No. 2001-290923).

Furthermore, there are techniques for dealing with the generation of forms. When a form for entering data is generated, the user is capable of selecting and limiting the usable form, and the form for data input to which user information has been added is generated (e.g., see Japanese Patent Application Laid-Open No. 8-315050).

When data is registered in a database with the prior-art techniques, however, a method of utilizing the data, expert knowledge and a special-purpose application or web browser for entering data are required. As a consequence, users who can utilize such services are limited and so are the information processing terminals for entering the data.

Further, in a case where a form for data input is generated, it is necessary to store and retain a template of a data input form that is separate from a template of a data output form.

### SUMMARY OF THE INVENTION

An object of the present invention is to make it possible to register data through a simple operation.

Another object of the present invention is to facilitate template management by making use of one template for both data registration and data output.

A further object of the present invention is to provide a data processing apparatus comprising: designating means for designating a template; reading means for reading data that has been recorded on a sheet; registration means for registering the read data in accordance with the template designated; and output means for outputting a data output sheet using the data and the designated template, and outputting a data registration sheet using the designated template.

A further object of the present invention is to provide a data processing method comprising the steps of: discriminating a designated template; outputting a data registration sheet using the designated template; reading data that has been recorded on a sheet; registering the read data in accordance with the designated template; and outputting a data output sheet using the data and the designated template.

Further features of the present invention will become apparent from the following description of exemplary embodiments (with reference to the attached drawings).

### BRIEF DESCRIPTION OF THE DRAWINGS

FIG. 1 is a diagram illustrating an example of the configuration of a form processing system according to a first embodiment of the present invention;

FIG. 2 is a block diagram illustrating the internal structure of a multifunction peripheral shown in FIG. 1;

FIG. 3 is a diagram useful in describing a form template set according to the first embodiment;

FIG. 4 is a flowchart illustrating processing for acquiring data from a CRM database or for registering data in the CRM database;

FIG. 5 is a diagram illustrating an example of user settings information in the first embodiment;

FIG. 6 is a diagram illustrating an example of a data input form according to the first embodiment;

FIG. 7 is a flowchart illustrating data registration processing in the first embodiment;

FIG. 8 is a diagram illustrating an example in which data has been entered on a form, which is shown in FIG. 6, for registering data that has been added on; and

FIG. 9 is a diagram illustrating an example in which data has been entered on a form for registering data anew.

### DESCRIPTION OF THE EMBODIMENTS

A preferred embodiment for practicing the present invention will now be described in detail with reference to the drawings.

A system that includes a network-supported digital multifunction peripheral (referred to as an “MFP” below) that uses a single template to acquire form data and to create and output a form will be described as a first embodiment.

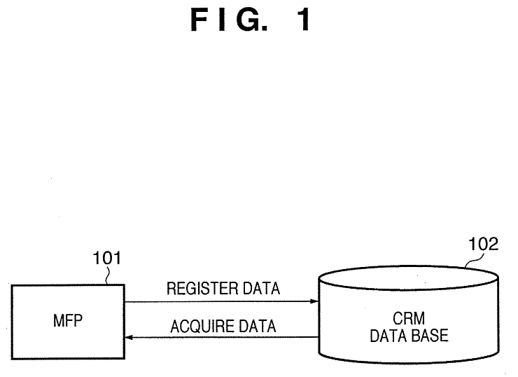

FIG. 1 is a diagram illustrating an example of the configuration of a form processing system according to the first embodiment. In FIG. 1, an MFP 101 serving as a data processing apparatus has a printing function and a scanning function. The MFP 101 and a CRM (Customer Relationship Management) database 102 are interconnected by a network, not shown.

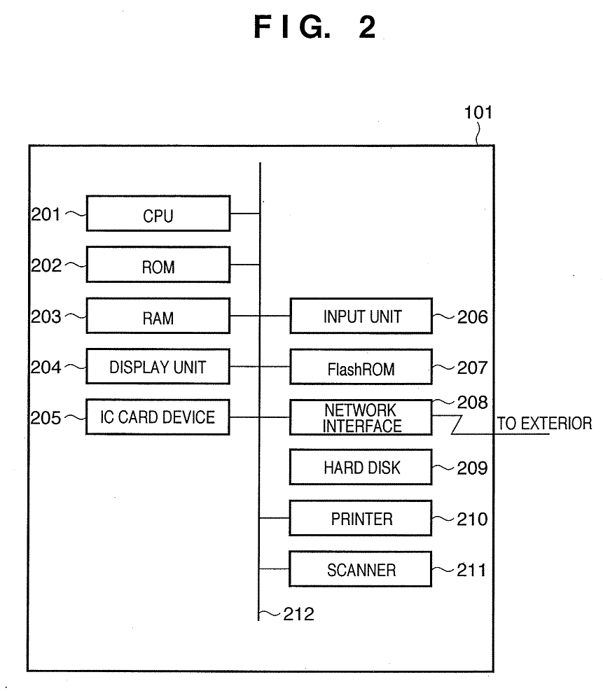

FIG. 2 is a block diagram illustrating the internal structure of the MFP 101 serving as the data processing apparatus of FIG. 1. The MFP 101 includes a CPU 201 for controlling the overall MFP 101 in accordance with a control program, described later; a ROM 202, which is a read-only memory for storing a control program executed by the CPU 201, and control data; and a RAM 203 for temporarily storing data acquired from the database, values that prevail during the running of a program, and generated form data.

The MFP 101 further includes a display unit 204 for displaying the status of the MFP 101 and for cooperating with an input unit, described later, to provide a user interface for assisting the user in operating the MFP 101; an IC card device 205 used to input user identification information for the purpose of user authentication; an input unit 206 constituted by buttons and the like for performing various operations; a flash ROM 207, which is a non-volatile memory for storing various set-data files; a network interface 208 for connecting to an external apparatus, the interface sending and receiving data to and from the database 102, i.e., controlling the sending and receiving of data when data is acquired and when data is registered; a hard disk 209 for storing the program that controls the MFP 101, a program for generating forms, form templates and settings data files; a scanner 211 for reading in documents, forms for adding on data, described later, and forms for creating data; and an internal bus 212.

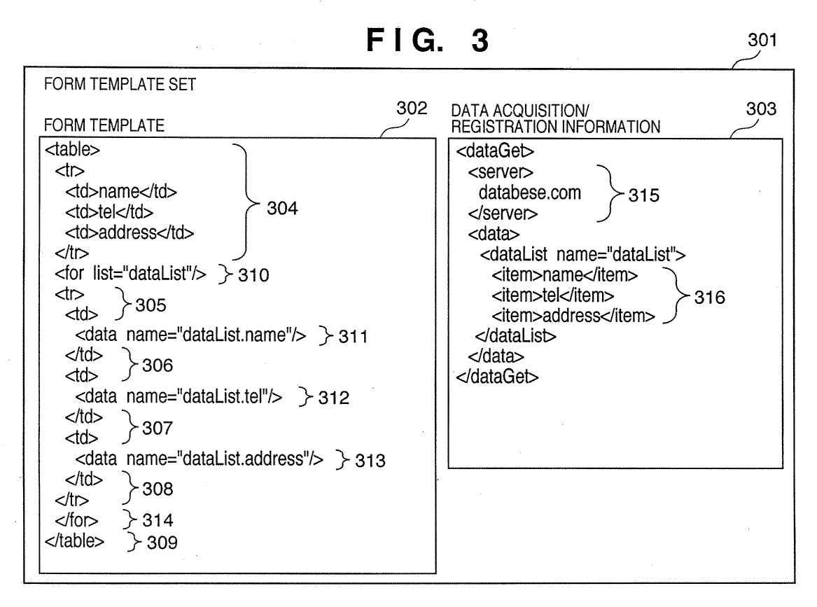

Next, a form template set used in the form processing system will be described with reference to FIG. 3. It should be noted that the form template set has been stored on the hard disk 209 in order to acquire data from the CRM database 102, add data to the CRM database 102 or create data.

FIG. 3 is a diagram useful in describing a form template set according to the first embodiment. As shown in FIG. 3, a form template set 301 is composed of a form template 302 and data acquisition/registration information 303.

“Form format information” (inclusive of item names) 304 to 309 and “merge information” 310 to 314 has been written in the form template 302. The merge information is information indicating how data is to be merged. In the illustrated example, the merge information describes that a template is to be merged with each of the elements “name”, “tel” and “address” contained in a list (dataList) of data.

A “database address” 315 and “data allocation information” 316 have been written in the data acquisition/registration information 303. In the illustrated example, it is illustrated that the data list is acquired from a server referred to as “databese.com”. Here the data list possesses the elements (items) “name”, “tel” and “address”. It is also illustrated that the data list having the elements (items) “name”, “tel” and “address” is registered in the server “databese.com”.

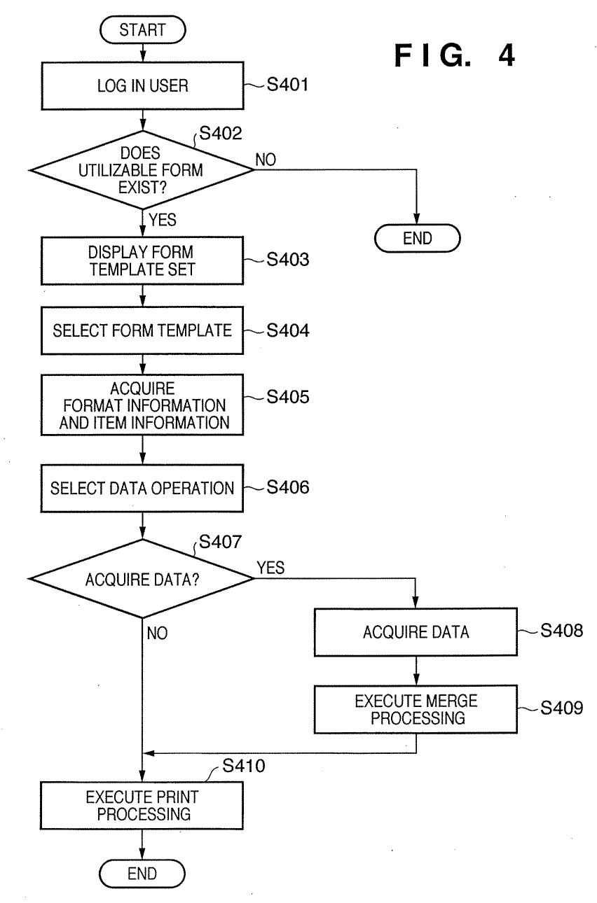

Next, reference will be had to FIG. 4 to describe processing for selecting a form template and performing printing in order to acquire data from the CRM database 102 or register data in the CRM database 102.

FIG. 4 is a flowchart illustrating processing for acquiring data from a CRM database 102 or for registering data in the CRM database 102. First, at step S401, the user causes the IC card device 205 of the MFP 101 to read in an IC card, whereupon the CPU 201 executes user authentication in accordance with the data on the IC card. If user authentication succeeds, the user is logged in.

It should be noted that user authentication is not limited to use of the IC card device 205 and may be performed by a method of entering a user account and password using the input unit 206. In a case where this other method is employed, the IC card device 205 will be unnecessary.

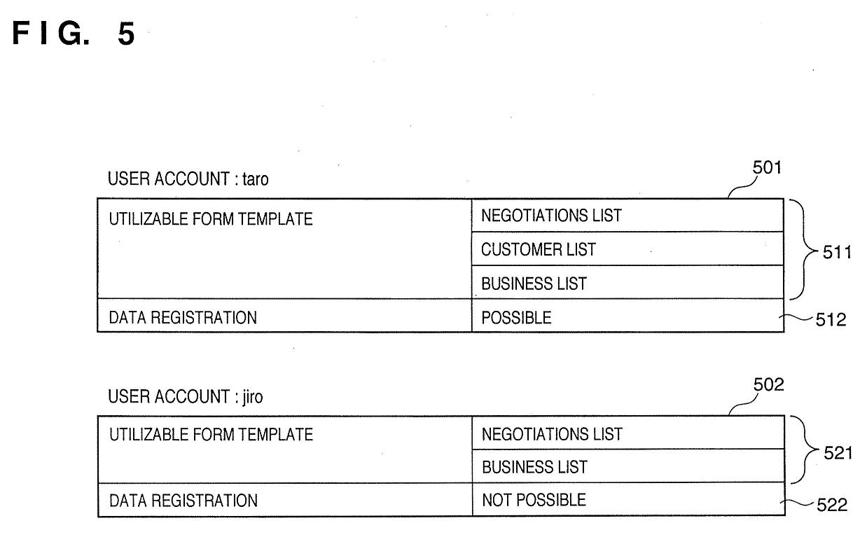

Next, at step S402, whether a form template that is capable of being utilized by the authenticated user who logged in at step S401 exists or not is determined. This processing, which is executed based upon the user account acquired at step S401, searches user settings information 501, 502 shown in FIG. 5 and determines whether a utilizable form template exists. As illustrated in FIG. 5, the user settings information 501, 502 contains, for every user, information 511, 521 on utilizable form lists and data-registration limiting information 512, 522. It is assumed that the user settings information 501, 502 has been recorded on the hard disk 209.

Processing is exited in a case where there is no existing utilizable form template in the user settings information corresponding to the user account acquired at step S401. If a utilizable form template does exist, however, then control proceeds to step S403. Here the display unit 204 displays the form template list of the logged-in user (a list of templates that can be utilized by the user, namely 511 for user account “taro” and 521 for user account “jiro” in the case of FIG. 5).

Next, at step S404, the form template used by the user is selected from the form template list by the display unit 204 or input unit 206. For example, if the display unit is constituted by a touch-sensitive panel, the user selects the form template by touching the panel. Further, the user may select the form template by designating the number of the form template using the input unit 206.

Next, at step S405, the form template selected at step S404 is acquired from the hard disk 209 and the format settings (304 to 309) and item information (“name”, “tel”, “address”) of the form to be output are acquired. This is followed by step S406, at which the user is allowed by the display unit 204 or input unit 206 to select the data operation to be executed. Here the user selects whether to acquire existing data from the database 102, register additional data in an existing data item in the database 102 or create and register a data item anew.

Next, at step S407, it is determined what data operation was selected by the user at step S406. In a case where acquisition of data is carried out, control proceeds to step S408. Here the database 102 is accessed and data acquired in accordance with the data acquisition/registration information 303. Then, at step S409, insertion of data is carried out in accordance with the data merge information 310 to 314 of the form template acquired at step S405, and a form for data output is printed by printer 210 at step S410.

In a case where it is determined at step S407 that registration of additional data in an item or creation and registration of a new data item is performed, control proceeds to step S410. Here the form template is printed by the printer 210 as a data input form in accordance with the format settings (304 to 309) of the form acquired at step S405. Processing in which the user enters data by handwriting in the data input form printed at step S410 and the handwritten data is read by the scanner 211 and registered in the database 102 will be described later.

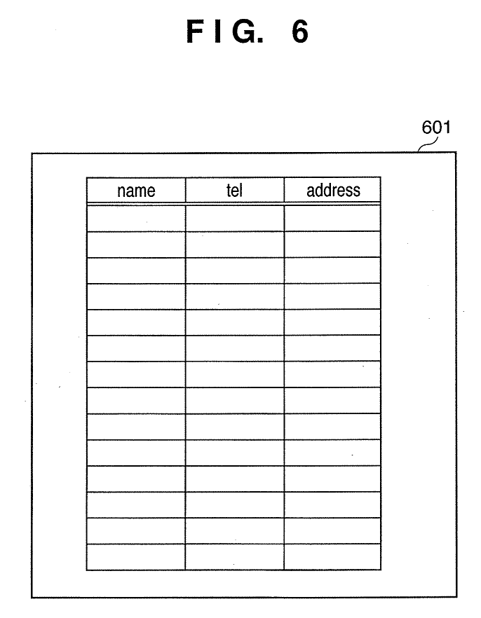

FIG. 6 is a diagram illustrating an example of a data input form according to the first embodiment. This form is created and printed based upon a template in a case where the user adds on and registers data. The user writes the data on the form in handwriting.

In FIG. 6, item names such as “name”, “tel” and “address” are acquired from the format settings 304 of the form template 302. (or from the data allocation information 316 of the data acquisition/registration information 303)

The data input form of FIG. 6 is a form in a case where an item name is output and the data of this item name is added on. However, in a case where an item is created anew and the data is registered, the item names such as “name”, “tel” and “address” are not output.

Thus, it is possible to execute print processing using a previously stored form template set both in a case where data is acquired from the database 102 and a case where data is registered in the database 102.

Next, processing for registering data in the CRM database 102 will be described with reference to the drawings.

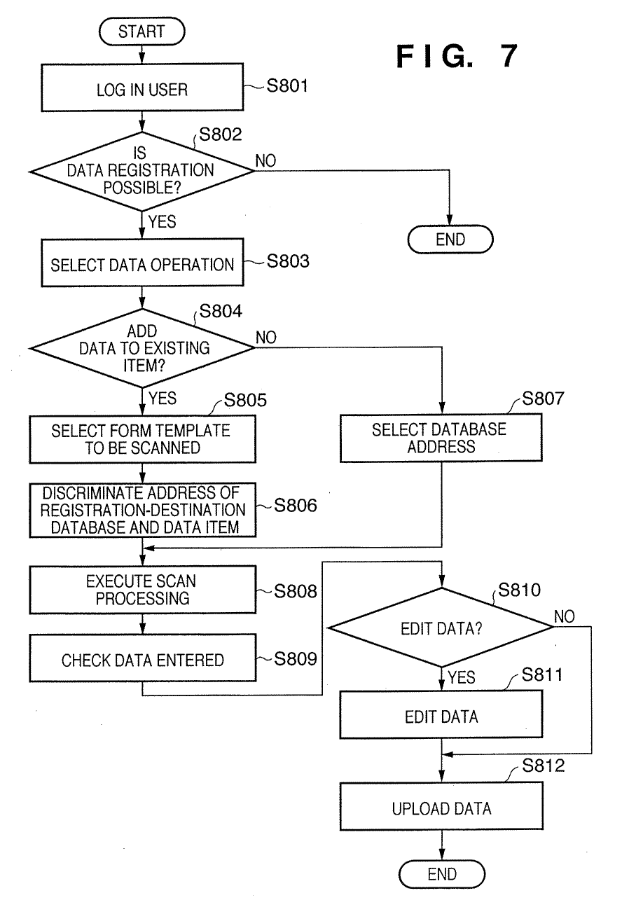

FIG. 7 is a flowchart illustrating data registration processing according to the first embodiment. First, at step S801, the user causes the IC card device 205 of the MFP 101 to read in an IC card, whereupon the CPU 201 executes user authentication in accordance with the data on the IC card. If user authentication succeeds, the user is logged in.

It should be noted that user authentication is not limited to use of the IC card device 205 and may be performed by a method of entering a user account and password using the input unit 206.

Next, at step S802, it is determined whether the authenticated user who logged in at step S801 is capable of registering data. This processing is processing for determining whether data registration is possible or not based upon the data-registration limiting information 512, 522 in the user settings information 501, 502 illustrated in FIG. 5.

If registration of data is not possible, processing is exited. If registration of data is possible, however, control proceeds to step S803, at which the user is allowed by the display unit 204 or input unit 206 to select the data operation to be executed. Here the user can select whether to register additional data in an existing data item in the database 102 or to create and register a data item anew.

Next, at step S804, it is determined what operation was selected by the user at step S803. In a case where the operation for registering additional data in an existing data item has been selected, control proceeds to step S805, where the user is allowed by the display unit 204 or input unit 206 to select from lists 511, 521 the form template to be scanned.

Next, the registration-destination address of the database and the data item are discriminated at step S806. The registration-destination address of the database is acquired from the database address 315 contained in the data acquisition/registration information 303 in the selected form template set. Further, the item name of the data to be registered is acquired from the data allocation information 316 of the data acquisition/registration information 303.

In a case where it is determined at step S804 that the operation for creating and registering an item in the data anew has been selected, control proceeds to step S807. Here the user is allowed by the display unit 204 or input unit 206 to select the address of the database in which the data will be registered. The database address is acquired from the data acquisition/registration information 303 of the template selected from the lists 511, 512. In this case, the form in which data is entered by the user is a form in which an item name has not been written.

Next, the data entered by the user is read utilizing the scanner 211 at step S808. The scanned data is then displayed on the display unit 204 at step S809 so that the content of the data entered by the user can be checked.

Next, at step S810, the user is allowed by the display unit 204 or input unit 206 to select whether the data entered by the user is to be edited or not. In a case where editing of the data has been selected, control proceeds to step S811, where editing of the data is performed using the display unit 204 or input unit 206. Further, if the operation for creating an item anew and registering it in the data base has been selected, the user can specify a character string or attributes of items such as data and time.

Next, if a registration button on the display unit 204 is pressed by the user at step S812, then the entered data is registered in the database 102.

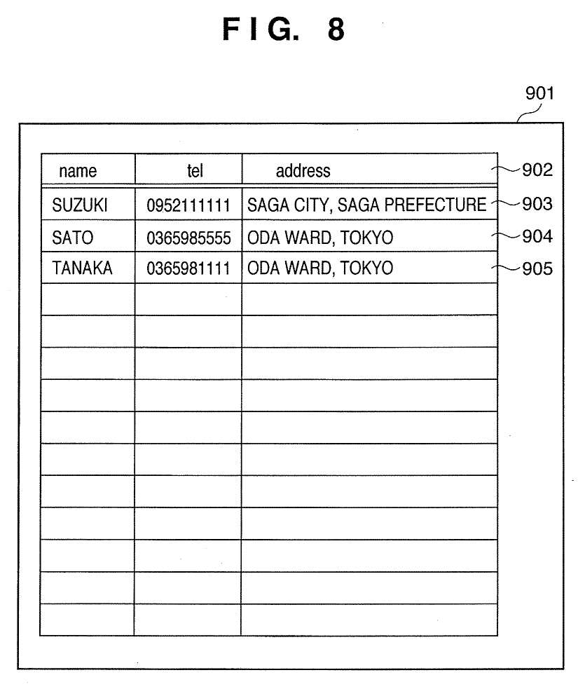

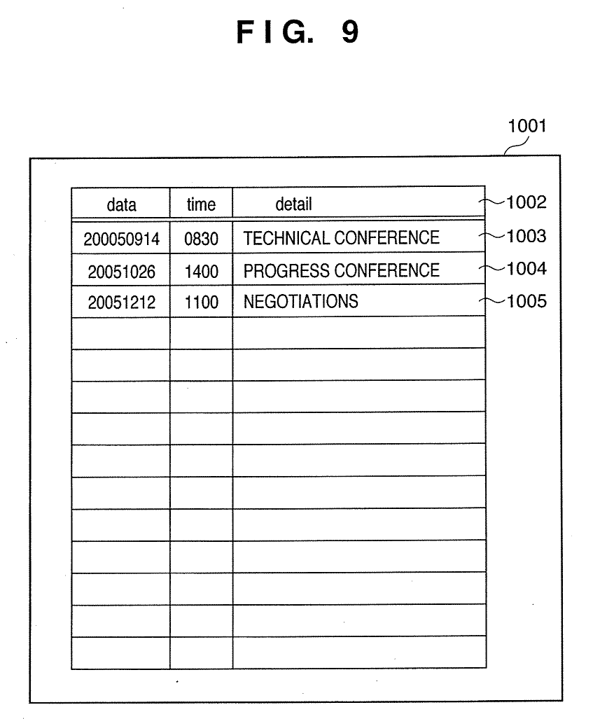

Next, the processing for reading the data and the data registration processing will be described in detail taking forms shown in FIGS. 8 and 9 as examples.

FIG. 8 is a diagram illustrating an example in which data has been entered on the form, which is shown in FIG. 6, for registering data that has been added on. A first line 902 of the form shown in FIG. 8 is read as an item name from item 304 of the form template 302 selected by the selection processing (S805) shown in FIG. 7. No registration of data in the database is performed with regard to this item name. In a case where data of a second line 903 is registered, data is registered in the database 102 from 311 of the form template 302 and 316 of data acquisition/registration information 303. In the example illustrated in FIG. 9, “Suzuki”, “09521111111” and “Saga City, Saga Prefecture” are registered as “name”, “tel” and “address”, respectively, in the database described at 315.

FIG. 9 is a diagram illustrating an example in which data has been entered on a form for registering data anew. Here “date”, “time” and “detail” on a first line 1002 of the form shown in FIG. 9 are discriminated as items and these are registered in the database selected by the selection processing (S807). In a case where data on a second line 1003 is registered, “20050914” is determined as being “date” read on the first line. Similarly, “0830” is determined as being “time” and “Technical Conference” is determined as being “detail”, and these are registered in the database that has been set by selection processing (S807).

Thus, the user is capable of entering data in a printed form for data registration, and the data can be registered in a database on a network merely by reading in the data.

The present invention can be applied to a system constituted by a plurality of devices (e.g., a host computer, interface, reader, printer, etc.) or to an apparatus comprising a single device (e.g., a copier or facsimile machine, etc.).

The object of the invention is attained also by supplying a recording medium storing the program codes of the software for performing the functions of the foregoing embodiment to a system or an apparatus, reading the program codes with a computer (e.g., a CPU or MPU) of the system or apparatus from the recording medium, and then executing the program codes.

In this case, the program codes read from the recording medium implement the novel functions of the embodiment and the recording medium storing the program codes constitutes the invention.

Examples of recording media that can be used for supplying the program code are a flexible disk, hard disk, optical disk, magneto-optical disk, CD-ROM, CD-R, magnetic tape, non-volatile type memory card or ROM, etc.

Furthermore, besides the case where the aforesaid functions according to the embodiment are implemented by executing the program codes read by a computer, the present invention covers a case where an operating system or the like running on the computer performs a part of or the entire process in accordance with the designation of program codes and implements the functions according to the embodiment.

The present invention further covers a case where, after the program codes read from the recording medium are written to a memory provided on a function expansion board inserted into the computer or provided in a function expansion unit connected to the computer, a CPU or the like provided on the function expansion board or in the function expansion unit performs a part of or the entire process in accordance with the designation of program codes and implements the function of the above embodiment.

While the present invention has been described with reference to an exemplary embodiment, it is to be understood that the invention is not limited to the disclosed exemplary embodiment. The scope of the following claims is to be accorded the broadest interpretation so as to encompass all such modifications and equivalent structures and functions.

This application claims the benefit of Japanese Patent Application No. 2006-111362, filed Apr. 13, 2006, which is hereby incorporated by reference herein in its entirety.

What is claimed is:

1. A data processing apparatus comprising:
designating means for designating a template;
reading means for reading data that has been recorded on a sheet;
registration means for registering the read data in accordance with the template designated; and
output means for outputting a data output sheet using the data and the designated template, and outputting a data registration sheet using the designated template.

2. The apparatus according to claim 1, wherein said output means acquires data in accordance with data acquisition information that corresponds to the designated template, and outputs the data output sheet using the acquired data and the designated template.

3. The apparatus according to claim 1, wherein said registration means registers the read data in a database that corresponds to the designated template.

4. The apparatus according to claim 1, wherein said output means outputs a sheet for adding an item to a database.

5. A data processing method comprising the steps of:
discriminating a designated template;
outputting a data registration sheet using the designated template;
reading data that has been recorded on a sheet;
registering the read data in accordance with the designated template; and
outputting a data output sheet using the data and the designated template.

6. The method according to claim 5, wherein said step of outputting the data output sheet includes acquiring data in accordance with data acquisition information that corresponds to the designated template, and outputting the data output sheet using the acquired data and the designated template.

7. The method according to claim 5, wherein said registration step includes registering the read data in a database that corresponds to the designated template.

8. The method according to claim 5, wherein said step of outputting the data registration sheet includes outputting a sheet for adding an item to a database.

9. A computer program, which is recorded on a computer-readable recording medium, for causing a computer to execute a data processing method, the method comprising the steps of:
discriminating a designated template;
outputting a data registration sheet using the designated template;
reading data that has been recorded on a sheet;
registering the read data in accordance with the designated template; and
outputting a data output sheet using the data and the designated template.

10. The program according to claim 9, wherein said step of outputting the data output sheet includes acquiring data in accordance with data acquisition information that corresponds to the designated template, and outputting the data output sheet using the acquired data and the designated template.

11. The program according to claim 9, wherein said registration step includes registering the read data in a database that corresponds to the designated template.

12. The program according to claim 9, wherein said step of outputting the data registration sheet includes outputting a sheet for adding an item to a database.
